(19) United States
(12) Patent Application Publication
(10) Pub. No.: US 2026/0138657 A1
(43) Pub. Date: May 21, 2026

(54) Rotating Handle for a Hand Truck

(71) Applicant: Magline, Inc., Standish, MI (US)

(72) Inventors: Gregory Paul Ecker, Midland, MI (US); Chad David Winters, Bay City, MI (US); Jesse Thomas Schopmeyer, Zeeland, MI (US); Scott Alexander Bokach, Wyoming, MI (US)

(21) Appl. No.: 19/360,305

(22) Filed: Oct. 16, 2025

Related U.S. Application Data
(60) Provisional application No. 63/723,215, filed on Nov. 21, 2024.

(51) Int. Cl. B62B 1/10; B62B 5/06

(52) U.S. Cl. CPC B62B 1/10; B62B 5/064; B62B 5/066

(57) ABSTRACT

A hand truck is disclosed, comprising an upper handle portion with a generally straight section, and a rotating handle encircling the upper handle portion. The rotating handle includes an outer surface designed for gripping and holding by a user, with the outer surface being textured or composed of a gripping material. The rotating handle further comprises an end portion on opposing distal ends and a center aperture through which the upper handle portion extends, allowing the rotating handle to rotate with respect to the upper handle portion and independent to the position of the hand truck. The rotating handle may be a singular piece or have a two-piece design. The two-piece design may include two identical halves about a longitudinal axis of the rotating handle. The rotating handle enables the user to grip the outer surface of the rotating handle and rotate the hand truck to a use position without needing to rotate their wrist or move their hand, thereby enhancing the ergonomics of the hand truck.

### CROSS-REFERENCE TO RELATED APPLICATION

This application claims the benefit of the priority date of United States Provisional Application Serial No. 63/723,215, filed on November 21, 2024, the contents of that application being incorporated by reference herein in their entirety and for all purposes.

### FIELD OF INVENTION

The present invention generally relates to a hand truck, more specifically, a rotating handle positioned to improve ergonomics. The present disclosure relates to light material handling equipment. Light material handling equipment encompasses a wide variety of wheeled carts, trollies, and hand trucks (e.g., dollies). These devices are typically manually operated by an operator who pushes or pulls the equipment. There are also motor-assisted (i.e., motorized) devices, which may include some type of device or mechanism to propel the device or cart without the operator having to exert a significant (or even zero) effort to cause the device to move.

### BACKGROUND

Generally, it is known to provide a wheeled device that typically stands vertically on two wheels and has an upper portion to be held by the operator to load carry cargo and to then tilt the loaded cargo and wheel the loaded cargo to a different location. It is also known to provide a hand truck including rear stabilizer wheels, which allow the hand truck to be tilted or leaned back and rested on the primary wheels and the rear stabilizer wheels. There is a wide variety of application-specific hand trucks based upon the above generally known designs. Such known application-specific hand trucks may be known as drum dollies (for moving 55-gallon drums), cylinder trucks (for moving high-pressure gas cylinders), tree dollies (for moving trees with ball roots), and water dollies (for moving multiple 5-gallon tanks of drinking water), to name only a few. It is generally known that any of these examples may be manually operated or may be motor-assisted devices.

It is also generally known that there is a vast amount of known hand trucks for many different uses. The known hand trucks vary a great deal and may include simple mechanical clamping mechanisms to secure the load to the truck and/or to provide for manual braking devices. It is also further known to provide more complex and motorized hand trucks that can lift and lower loads. There are many adaptations and versions of hand trucks to meet the many varying needs of specific uses or applications, since a hand truck may be used in so many ways and in so many industries.

Accordingly, an improved method and systems for improving ergonomics are needed in the industry.

### BRIEF DESCRIPTION OF THE DRAWINGS

The operation of the invention may be better understood by reference to the detailed description taken in connection with the following illustrations, wherein:

FIG. 1 illustrates several embodiments of a prior art hand truck of varying models;

FIG. 2 illustrates several embodiments of a new novel hand truck of varying models;

FIG. 3 illustrates a perspective view of a rotating handle for use with a hand truck;

FIG. 4 illustrates a perspective view of an alternative embodiment of the rotating handle connected to the hand truck;

FIG. 5 illustrates a perspective view of one half of an alternative embodiment of the rotating handle;

FIG. 6 illustrates a perspective view of one half of an alternative embodiment of the rotating handle;

FIG. 7 illustrates a perspective view of an alternative embodiment of the rotating handle; and

FIG. 8 illustrates a top perspective view of an alternative embodiment of the rotating handle connected to the hand truck.

### DETAILED DESCRIPTION

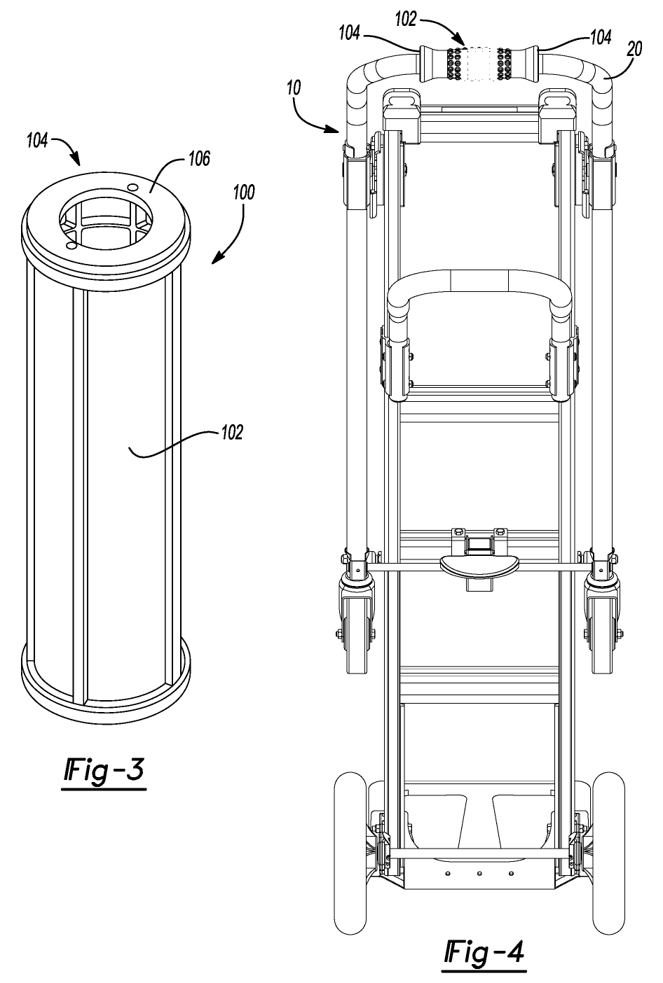

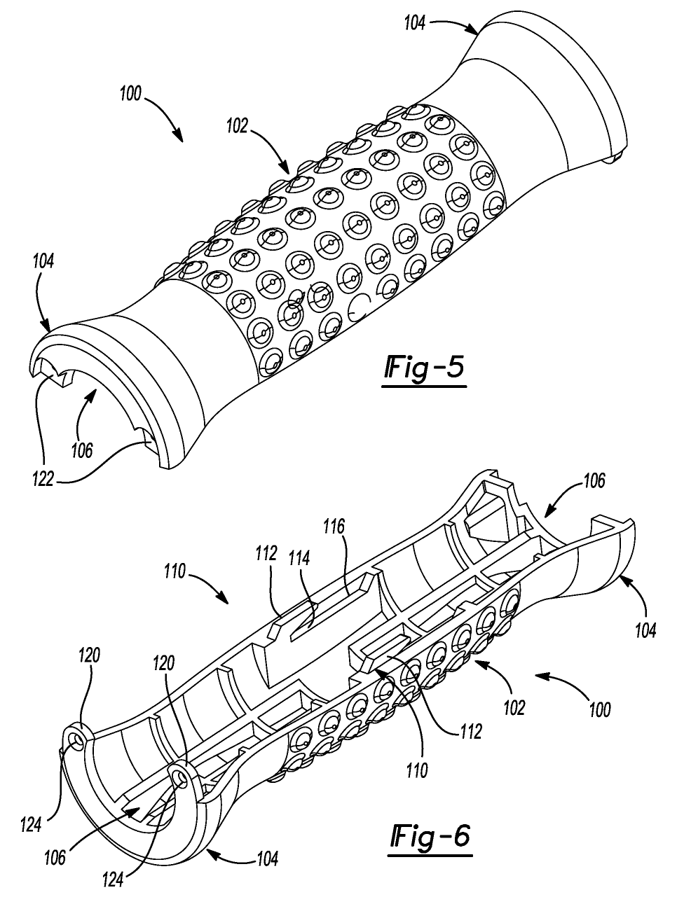

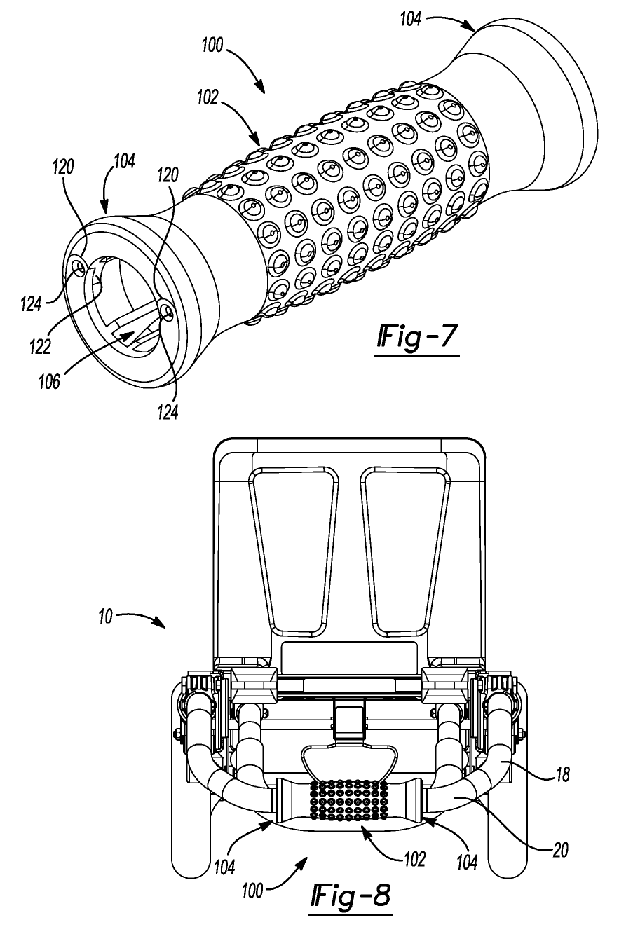

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. For example, the embodiment of the rotating handle of FIG. 3 may have a two-piece design and/or the same mating features as is shown in the embodiment depicted in FIGS. 5-7. Additionally or alternatively, the embodiment of the rotating handle of FIG. 3 may have a textured outer surface as is shown in the embodiment depicted in FIGS. 4-7. These examples are not exhaustive, and other combinations of features from the different embodiments may be realized. As such, the following description is presented by way of illustration only and should not limit in any way the various alternatives and modifications that may be made to the illustrated embodiments and still be within the spirit and scope of the invention.

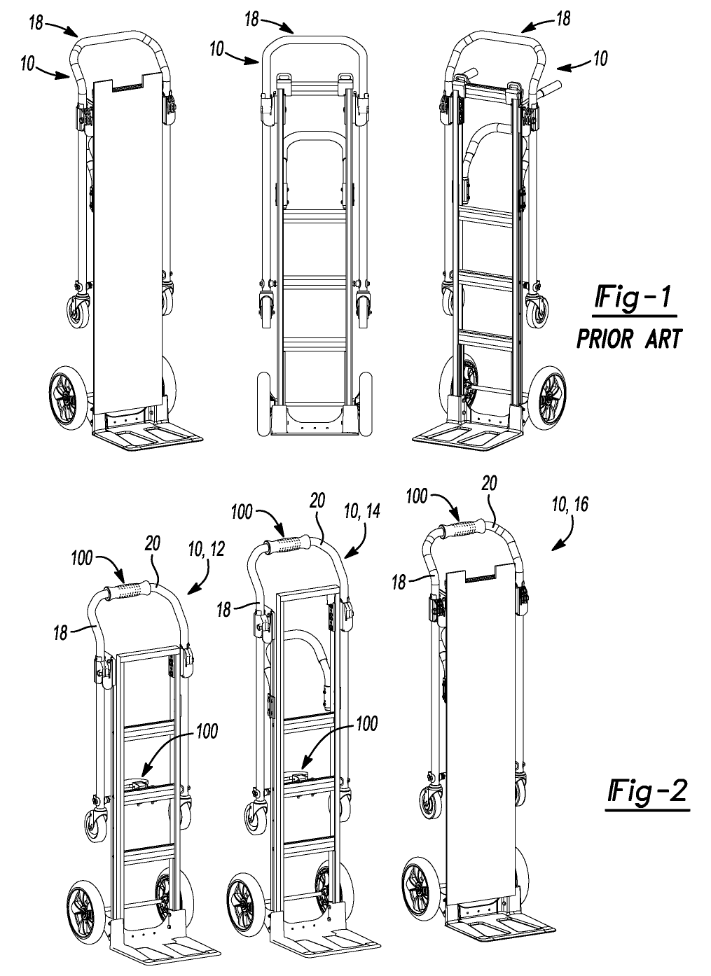

Hand trucks, also known as dollies, are essential tools for transporting heavy loads with minimal effort. FIG. 1 depicts several embodiments of prior art hand trucks 10 in varying models, which have been widely used for various applications. These traditional hand trucks 10 typically feature a sturdy frame, an upper handle portion 18, a pair of wheels, and a load-bearing platform or toe plate. The various models are designed for varying loads, including lighter loads, medium loads, and heavy loads. While these prior art hand trucks 10 have served their purpose effectively, they have certain limitations in terms of maneuverability, load capacity, and user ergonomics.

In contrast, FIG. 2 showcases several embodiments of a new, novel hand truck 10, also available in several models 12, 14, and 16. This innovative design addresses the limitations of the prior art by incorporating advanced features that enhance performance and user experience. For instance, the new hand truck models 12, 14, and 16 may include improved wheel configurations, such as swivel or multi-directional wheels, which significantly enhance maneuverability in tight spaces. Additionally, these models 12, 14, and 16 may feature an adjustable upper handle portion 18 that can be set to different heights, ensuring ergonomic comfort for users of varying statures.

The novel hand truck design also emphasizes increased load capacity and stability. The varying models are constructed with high-strength materials that allow them to carry heavier loads without compromising structural integrity. Reinforced frames and enhanced load-bearing platforms ensure that the hand trucks 10 can handle a greater variety of items, from small packages to bulky equipment. Moreover, the incorporation of advanced load-securing mechanisms, such as adjustable straps or clamps, helps to prevent shifting and ensures that the transported items remain securely in place during transit.

Furthermore, the new hand truck models 12, 14, and 16 prioritize ease of use and versatility. They may include features such as foldable frames for convenient storage and transport, as well as modular components that allow for easy customization based on specific needs. For example, users can attach different types of wheels or load-bearing platforms depending on the nature of the load.

Moreover, the hand truck models 12, 14, and 16 may include a rotating handle 100, improving ergonomics and usability for the user. The rotating handle 100 may rotate independently of the angle of the hand truck 10, allowing the user to maintain their grip on the upper handle portion 18 while the hand truck 10 is being tipped or returned to an upright position. Overall, the novel hand trucks 10 in the varying models 12, 14, and 16 represent a significant advancement over prior art, offering enhanced functionality, durability, and user comfort.

FIGS. 2-8 illustrate different embodiments of a rotating handle 100, in some figures, connected to a hand truck 10. The hand trucks 10 are depicted in various models 12, 14, and 16 and include and upper handle portion 18 having a generally straight portion 20, allowing for the rotating handle 100 to be attached thereto.

The rotating handle 100 includes an outer surface 102 intended for gripping and holding by the user. The outer surface 102 may be textured or made of a gripping material to allow for better handling. The rotating handle 100 further includes an end portion 104 and a center aperture 106. An end portion 104 is located on each distal end of the rotating handle 100. The center aperture 106 is adapted to encircle the upper handle portion 18 of the hand truck 10. The rotating handle 100 may be substantially cylindrical in shape, or alternatively, have a generally curved profile adapted to accommodate a user’s hand shape. The rotating handle may include flared end portions 104.

Once installed, the rotating handle 100 is capable of rotating with respect to the handle portion 18. In some embodiments, the center portion of the rotating handle 100 is fixed and immovable with respect to the upper handle portion 18 and the outer surface 102. In this embodiment, the user can grip the rotating handle, specifically the outer surface 102, and rotate the hand truck 10 to a use position (such as pulling or pushing). In this embodiment, the user does not need to rotate their wrist or move their hand when using the hand truck 10, thereby improving the ergonomics of the hand truck 10as a whole. This ergonomic improvement is particularly beneficial for users who need to operate the hand truck 10 for extended periods, as it reduces the strain on the wrist and hand, potentially preventing repetitive strain injuries.

Additionally, the rotating handle 100 can be designed with various locking mechanisms to secure it in a desired position when not in use. For instance, a spring-loaded pin or a twist-lock mechanism can be incorporated to prevent unintended rotation during transportation or storage. This feature ensures that the handle remains stable and does not rotate freely, providing additional safety and convenience. Furthermore, the rotating handle's 100 outer surface 102 can be customized with different textures or materials, such as rubber or foam, to cater to different user preferences and enhance the overall user experience.

Moreover, the rotating handle 100 can be adapted for use with various types of hand trucks 10, including those designed for specific industries such as delivery services, warehouses, or retail. By offering a versatile and ergonomic solution, the rotating handle 100 can significantly improve the efficiency and comfort of hand truck 10 operations across different sectors. The ability to retrofit existing hand trucks 10 with the rotating handle 100 also provides a cost-effective way to upgrade equipment without the need for purchasing entirely new hand trucks. This adaptability and ease of installation make the rotating handle 100 a valuable addition to any hand truck 10, enhancing its functionality and user-friendliness.

The rotating handle 100 may be a one-piece design, as is depicted in FIG. 3, or a two-piece design, as is depicted in FIGS. 5-7. Alternatively, designs with more than two pieces may be envisioned as well.

FIGS. 5-7 depict the two-piece design of the rotating handle, the two-piece design including two identical halves about a longitudinal axis of the rotating handle. The identical halves allow for streamlined manufacturing, as fewer parts need to be made. Furthermore, the two-piece design with identical halves allows for simplified and cheaper replacement because the pieces are interchangeable. Further, the design allows a user to replace only one half of the rotating handle 100, if needed, as opposed to replacing the entire rotating handle 100. The two identical halves may be adapted to mate when the longitudinal orientation of a first half of the rotating handle 100 is rotated 180° relative to the longitudinal orientation of a second half of the rotating handle 100.

In addition to the outer surface 102, end portions 104, and center aperture 106, the two-piece embodiment of the rotating handle 100 includes one or more mating structures 110, preferably two mating structures 100 per half of the rotating handle 100. As such, the rotating handle 100 is provided with two connection points. While the mating structures 100 are depicted as being centrally located along the length of the rotating handle 100, the mating structures 110 may be located anywhere along the rotating handle 100.

The mating structure 110 includes an interlocking hook 112, an interlocking recess 114, and a sliding track 116. The interlocking hook 112 may be located at one end of the sliding track 116, and the interlocking recess 114 may be formed between the interlocking hook 112 and the sliding track 116. An interlocking hook 112 of a first half of the rotating handle 100 may be placed against and laterally slid along the sliding track 116 of a second half of the rotating handle 100 until the interlocking hook 112 of the first half engages the interlocking recess 114 of the second half. While the mating structure 100 is illustrated as having a hook and a recess, any reciprocally shaped mating structures may be realized to secure the two-piece design of the rotating handle 100 together.

Additionally, each end portion 104 of each half of the two-piece design may also have an end mating structure 118. The end mating structure may include one or more end protrusions 120, one or more end recesses 122, or a combination thereof. For example, a first end portion 104 may have an end mating structure 118 that includes two end protrusions 120, while a second end portion 104 may have an end mating structure 118 that includes two end recesses 122. The one or more end recesses 122 on one half of the two identical halves are adapted to receive one or more end protrusions 120 on another half of the two identical halves. For example, when the two pieces of the rotating handle 100 are mated, the one or more end protrusions 120 may mate with one or more end recesses 122.

The one or more end protrusions 120, the one or more end recesses 122, or both may further include one or more fastener apertures 124 through which a fastener, such as a screw or bolt (not shown), may pass therethrough. The fastener aperture 124 in an end protrusion 120 may be aligned with a fastener aperture 124 in an end recess 122 such that when the end protrusion 120 and the end recess 122 are mated, the fastener apertures 124 are adapted the allow a fastener (not shown) to pass through both structures, further securing the two-pieces of the rotating handle 100 together.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms "substantially" and "about" may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner. As can be seen, the teaching of amounts expressed as "parts by weight" herein also contemplates the same ranges expressed in terms of percent by weight. Thus, an expression in the Detailed Description of the Invention of a range in terms of at "'x' parts by weight of the resulting polymeric blend composition" also contemplates a teaching of ranges of the same recited amount of "x" in percent by weight of the resulting polymeric blend composition."

Unless otherwise stated, all ranges include both endpoints and all numbers between the endpoints. The use of "about" or "approximately" in connection with a range applies to both ends of the range. Thus, "about 20 to 30" is intended to cover "about 20 to about 30", inclusive of at least the specified endpoints.

The term "consisting essentially of" to describe a combination shall include the elements, ingredients, components, or steps identified, and such other elements, ingredients, components, or steps that do not materially affect the basic and novel characteristics of the combination. The use of the terms "comprising" or "including" to describe combinations of elements, ingredients, components, or steps herein also contemplates embodiments that consist essentially of, or even consist of, the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of "a" or "one" to describe an element, ingredient, component, or step is not intended to foreclose additional elements, ingredients, components, or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A hand truck comprising:
an upper handle portion having a generally straight section;
a rotating handle encircling the upper handle portion, the rotating handle comprising:
an outer surface configured for gripping and holding by a user, the outer surface being textured or made of a gripping material;
an end portion on opposing distal ends; and
a center aperture through which the upper handle portion extends;
wherein the rotating handle is capable of rotating with respect to the upper handle portion and independent to a position of the hand truck; and
wherein, in use, the user can grip the outer surface of the rotating handle and rotate the hand truck to a use position without needing to rotate their wrist or move their hand, thereby improving the ergonomics of the hand truck.

2. The hand truck of claim 1, wherein the outer surface includes a plurality of nubs.

3. The hand truck of claim 1, wherein the outer surface is made of rubber.

4. The hand truck of claim 1, wherein the rotating handle is substantially cylindrical in shape.

5. The hand truck of claim 1, wherein the rotating handle has a generally curved profile adapted to accommodate a user’s hand shape.

6. The hand truck of claim 1, wherein the rotating handle is a singular piece.

7. The hand truck of claim 1, wherein the rotating handle is formed from two pieces.

8. The hand truck of claim 7, wherein the two pieces are two identical pieces about a longitudinal length of the rotating handle.

9. A hand truck comprising:
an upper handle portion having a generally straight section;
a rotating handle encircling the upper handle portion, the rotating handle comprising:
an outer surface configured for gripping and holding by a user, the outer surface being textured or made of a gripping material;
an end portion on opposing distal ends; and
a center aperture through which the upper handle portion extends;
wherein the rotating handle includes two identical halves about a longitudinal axis of the rotating handle;
wherein the two identical halves are adapted to mate when the longitudinal orientation of a first half is rotated 180° relative to the longitudinal orientation of a second half;
wherein the rotating handle is capable of rotating with respect to the upper handle portion and independent to a position of the hand truck; and
wherein, in use, the user can grip the outer surface of the rotating handle and rotate the hand truck to a use position without needing to rotate their wrist or move their hand, thereby improving the ergonomics of the hand truck.

10. The hand truck of claim 9, wherein the two identical halves mate via one or more mating structures located on each half of the two identical halves.

11. The hand truck of claim 9, wherein each end portion is adapted to accommodate one or more fasteners, the one or more fasteners securing the two identical halves together after the two identical halves are mated.

12. The hand truck of claim 9, wherein the outer surface includes a plurality of nubs.

13. The hand truck of claim 9, wherein the outer surface is made of rubber.

14. The hand truck of claim 9, wherein the rotating handle is substantially cylindrical in shape.

15. The hand truck of claim 9, wherein the rotating handle has a generally curved profile adapted to accommodate a user’s hand shape.

16. A rotating handle including two identical halves about a longitudinal axis of the rotating handle, each half of the two identical halves including at least one mating structure;
wherein each mating structure of the at least one mating structure includes:
a sliding track;
an interlocking hook located at one end of the sliding track; and
an interlocking recess formed between the interlocking hook and the sliding track;
wherein the two identical halves are mated when the interlocking hook of a first half of the two identical halves is placed against and laterally slid along the sliding track of a second half of the two identical halves until the interlocking hook of the first half engages the interlocking recess of the second half.

17. The rotating handle of claim 16, wherein the each half includes two mating structures.

18. The rotating handle of claim 16, wherein the interlocking hook is reciprocally shaped with the interlocking recess.

19. The rotating handle of claim 16, wherein the each half further includes at least one end mating structure, the at least one end mating structure includes one or more end protrusions, one or more end recesses, or a combination thereof; and
wherein the one or more end recesses on one half of the two identical halves is adapted to receive the one or more end protrusions on another half of the two identical halves.

20. The rotating handle of claim 19, wherein the one or more end protrusions, the one or more end recesses, or both include one or more fastener apertures; and
wherein the one or more fastener apertures in an end protrusion is adapted to align with the one or more fastener apertures in an end recess such that a fastener can pass therethrough to secure the two identical halves of the rotating handle when mated.
